(19) United States
(12) Patent Application Publication
(10) Pub. No.: US 2009/0321077 A1
(43) Pub. Date: Dec. 31, 2009

(54) Pigging Of Flowlines By In-Situ Generated Foam Pigs

(76) Inventor: David A. Norman, Houston, TX (US)

Correspondence Address: Exxon Mobil Upstream;Research Company, P.O. Box 2189, (CORP-URC-SW 359), Houston, TX, 77252-2189, US

(21) Appl. No.: 12/518,220

(22) PCT Filed: Dec. 18, 2007
(86) PCT No.: PCT/US07/25815

§ 371 Date: Jun. 8, 2009

Related U.S. Application Data
(60) Provisional application No. 60/898,305, filed on Jan. 30, 2007.

(51) Int. Cl. E21B 37/00; F16K 51/00

(52) U.S. Cl. 166/311; 137/242

(57) ABSTRACT

Methods and apparatus utilized to form foam pigs in-situ are provided. The in-situ generated foam pigs may be used for a number of purposes, including, but not limited to, commissioning or operational pigging. Further, the in-situ generated foam pigs may be used in a variety of type flowlines, including, but not limited to production or transportation pipelines used to carry hydrocarbons from subsea wells over long distances.

### REFERENCE TO PRIORITY APPLICATION

This application claims the benefit of U.S. Provisional Application No. 60/898,305 filed on Jan. 30, 2007.

### BACKGROUND OF THE INVENTION

1. Field of the Invention

Embodiments of the invention generally relate to a method and apparatus for pigging a flowline configured for transporting production fluids.

2. Description of the Related Art

Flowlines, which may constitute or be a part of a fluid transportation system, are commonly used as conduits to carry hydrocarbons or other fluids between subsea wells and production platforms during deepwater oil and gas production. Such flowlines are pigged for various reasons, such as commissioning of new lines, periodically cleaning the line of accumulated wax, scale, or other debris, and/or periodically delivering batch chemical treatments, such as a corrosion inhibitor.

Accordingly, various approaches for pigging flowlines have been developed. Typically, round-trip pigging operations are employed, which may require two flowlines between a production platform and a subsea well. In a round-trip pigging operation, a pig is launched from the production platform and travels through the first flowline to the subsea well. It is then diverted from the first flowline to the second flowline. Finally, the pig returns to the production platform through the second flowline. However, as the distance between the subsea well and production platform increases, the cost of installing two flowlines for round-trip pigging may be cost prohibitive.

Approaches that allow pigging through a single flowline can significantly reduce cost versus the two flowlines used for round-trip pigging. An approach for one-way pigging is to use a subsea pig launcher. A subsea pig launcher is a device installed on the seafloor near a subsea well that can launch a pig into a flowline to a production platform. Subsea pig launchers generally include a cartridge that stores multiple pigs. The drawback of subsea pig launchers is that they require periodic replacement of this cartridge by a remotely operated vehicle (ROV). As a result, this approach may be maintenance intensive.

Another potential approach for one-way pigging is to use a gel pig. A gel pig is a slug of a highly viscous fluid that is pumped through a line for periodic cleaning. Such a fluid could be delivered to the flowline near the subsea well and then be pumped back to the production platform. However, gel pigs lack mechanical integrity and are often be used in conjunction with mechanical brush or displacement pigs. These mechanical pigs typically require round-trip pigging or a subsea pig launcher. The number of applications where a gel pig may be used without a mechanical pig is limited.

Yet another approach that has been proposed for one-way pigging is to create a foam pig in a chamber adjacent to the flowline and introduce it into the flowline (U.S. Pat. No. 3,498,838). While this concept has promise, there are several improvements that can be made to tailor it to long-distance, subsea flowlines.

### SUMMARY OF THE INVENTION

Embodiments of the present invention generally provide methods and apparatus for forming foam pigs in-situ.

One embodiment provides a method of operating a fluid transportation system. The method generally includes flowing one or more precursors into a first portion of a fluid transportation system, curing the precursors within the fluid transportation system to form a foam pig, moving the foam pig through a second portion of the fluid transportation system, and repeating the flowing, curing, and moving steps at different locations along the fluid transportation system.

In another embodiment, a method for pigging a flowline configured for transporting production fluids is described. This method generally includes a plurality of chambers in communication with a flowline. Precursors are flowed into at least one of the plurality of chambers to form a foam pig in-situ by allowing the precursors to cure in at least one of the plurality of chambers. Back pressure is built in at least one of the plurality of chambers and the pig is launched from at least one of the plurality of chambers into the flowline. The pig may comprise a rigid foam pig, while the precursors may be injected into at least one of the plurality of chambers via one or more remotely operated valves.

In a third embodiment, a system for in-situ formation of a foam pig for pigging a subsea flowline configured to transport production fluids is provided. The system comprises a plurality of chambers in fluid communication with the flowline. A pair of valves is mounted on opposing ends of each of the plurality of chambers with the pair of valves including a kicker valve located at an upstream end of each of the plurality of chambers and a chamber isolation valve located at a downstream end of each of the plurality of chambers. One or more injection valves are also connected with each of the plurality of chambers with the injection valves configured to deliver one or more precursors to each of the plurality of chambers for formation of the foam pig. The system further comprises a control apparatus, which may be located at the surface, allowing in-situ formation of the foam pig by remotely operating the pair of valves and the one or more injection valves to: a) isolate at least one of the plurality of chambers from the flowline by closing the kicker valve and chamber isolation valve; b) flow the one or more precursors into the at least one of the plurality of chambers by opening the injection valves, and, after allowing the precursors to cure to form the foam pig, c) opening the kicker valve to build back pressure in the at least one of the plurality of chambers, and d) opening the chamber isolation valve to propel the foam pig into the flowline.

In fourth embodiment, a fluid transportation system generally includes a flowline for transporting fluids and a plurality of pig forming apparatuses. Each of the plurality of pig forming apparatuses is located at a different position along the flowline and configured to form, from one or more precursors cured in-situ, a pig to be moved through a portion of the flowline.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram for a process of generating an in-situ foam pig in accordance with one embodiment of the present invention;

FIG. 2 a schematic diagram of one embodiment of an apparatus for generating an in-situ pig in accordance with one embodiment of the present invention;

FIGS. 3A-3F are schematic diagrams for a process of generating an in-situ pig using the system in accordance with one embodiment of the present invention;

FIG. 4 is a schematic diagram of another embodiment of a system for generating an in-situ pig in accordance with one embodiment of the present invention;

FIG. 5 is a schematic diagram of one embodiment of a mixing apparatus for generating an in-situ pig in accordance with one embodiment of the present invention; and

FIG. 6 illustrates an exemplary fluid transportation system with in-situ foam pig generation apparatus located along a pipeline.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

In the following detailed description section, the specific embodiments of the present invention are described in connection with preferred embodiments. However, to the extent that the following description is specific to a particular embodiment or a particular use of the present invention, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

### Introduction and Definitions

Embodiments of the present invention provide methods and apparatus that may be used to form foam pigs in-situ. The in-situ generated foam pigs could be used for a number of purposes, including, but not limited to, commissioning or operational pigging. Further, the in-situ generated foam pigs may be used in a variety of type flowlines, including, but not limited to flowlines used to carry hydrocarbons from subsea wells to a production platform or other suitable flowlines or fluid flow paths.

Forming the pigs in-situ, as described herein, may have a number of advantages. As an example, it may provide one-way pigging, eliminating the need for dual flowlines. As another example, forming pigs in-situ may provide a less maintenance intensive approach to one-way pigging than a subsea pig launcher, because it eliminates the need to replenish cartridges. As yet another example, it may allow one-way pigging in very long flowlines or pipelines by constructing or fitting in-situ foam pig launchers at several points spaced along the length of the flowlines. For instance, subsea pipelines may be hundreds of miles long, and a foam pig may wear over such distances, losing its ability to effectively clean the line. Generating in-situ foam pigs at several points along the flowline may allow the entire flowline or large portions to be cleaned efficiently with foam pigs. Furthermore, launching a pig has potential safety risks, and performing this operation remotely can reduce risk to personnel versus launching a pig from a manned facility.

As used herein, the term pig generally refers to a device inserted into a flowline pipeline for cleaning purposes. In some cases, the pressure of the flow behind the pig may push the pig along the pipeline to clean out various deposits, such as corrosion products, scale, wax, and other types of debris. As used herein, the term pigging generally refers to the act of moving a pig through a pipeline, typically for the purposes of cleaning or inspecting the line.

As used herein, the term foam pig generally refers to any type of pig formed, at least partially, of a deformable material having any suitable density. Various properties of a foam pig, such as amount of deformability (and rigidity), dimensions, and the like, may be selected based on the parameters of a particular application, such as the type of buildup to be cleaned, dimensions of the pipeline, length of pipeline to be pigged, and the like.

As used herein, the term in-situ generally refers to a location at or near a pipeline into which a pig is to be deployed. As used herein, the term pipeline generally refers to any tubular member or system of tubular members used for transporting hydrocarbons, for example, from a wellhead to a production facility.

As used herein, the terms upstream and downstream generally refer to locations relative to a direction of flow. In other words, a position may be referred to as upstream relative to a downstream position if the direction of the flow is from the upstream position to the downstream position.

To facilitate understanding the following description refers to in-situ formation of a foam pig for use in a subsea pipeline as a specific, but not limiting, application example. However, those skilled in the art will recognize a foam pig formed in-situ in the manner described herein may be used for pigging a number of different types of flowlines, tubular member and/or fluid transportation systems. Further, those skilled in the art will recognize that foam pigs formed in-situ, as described herein, may be used in combination with any type of conventional pigs, such as mechanical, gel, and/or conventionally formed foam pigs.

### EXEMPLARY EMBODIMENTS

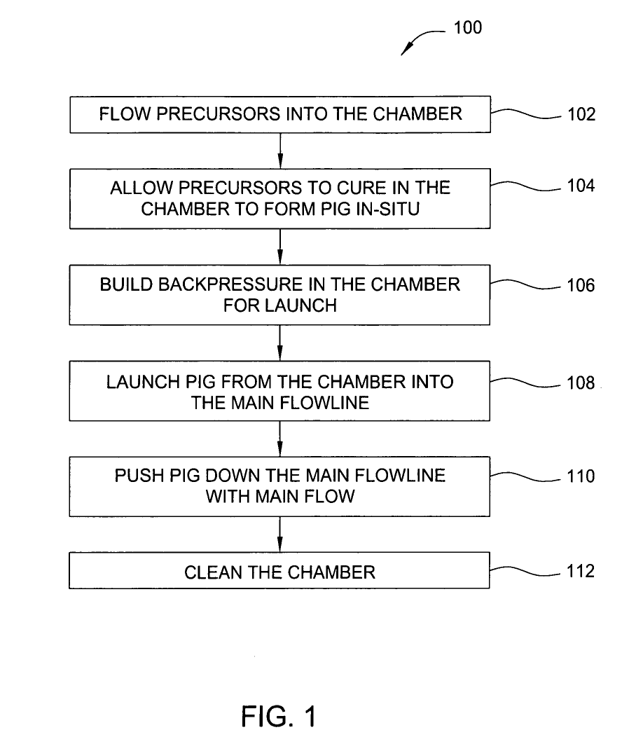

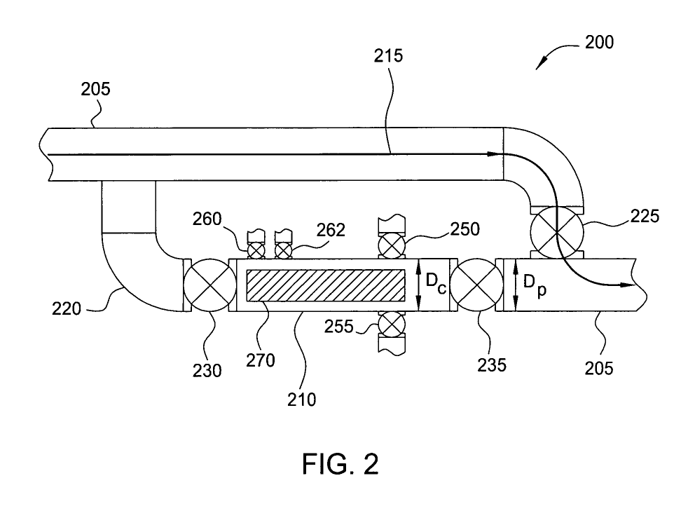

FIG. 1 illustrates a flow diagram of exemplary pigging operations for forming a foam pig in-situ. The pigging operations may be performed utilizing any suitable components. To facilitate understanding, the pigging operations may be described as being performed utilizing the components shown in FIG. 2. However, it should be understood that the pigging operations may be performed utilizing any suitable components. Further, it should be understood that the components shown in FIGS. 2-6 may be utilized to perform operations other than those shown in FIG. 1 further, the operations shown in FIG. 1 may be performed in a different order than that which is shown in FIG. 1.

An in-situ generated foam pigging operation 100 begins by flowing one or more precursors into a chamber, at block 102. The precursors may represent components of a thermosetting resin system that react to form a rigid foam when mixed (e.g. two-component polyurethane resin system). It is also possible to base the operation on foam pigs made from a thermoplastic foam, such as polystyrene. This type of foam pig may include mixing a thermoplastic and a gaseous foaming agent, such as polystyrene and carbon dioxide.

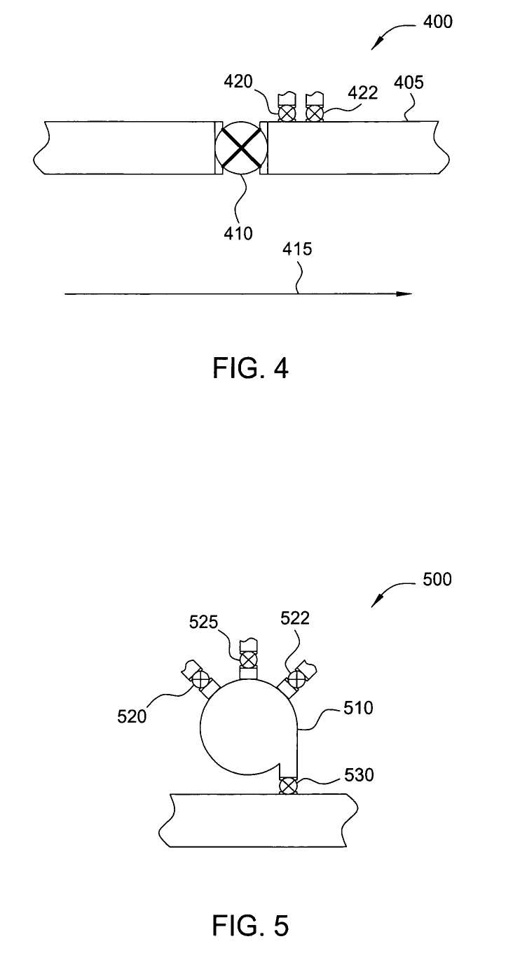

At block 104, the precursors are cured in the chamber to form the foam pig in-situ. For some embodiments, the chamber may be a separate chamber, for example, dedicated for the formation of a foam pig in-situ, as shown in FIG. 2. For other embodiments, rather than a separate chamber, a portion of a flowline may be used as a chamber, as shown in FIG. 4. For some embodiments, multiple precursors may be flowed into the chamber via flowlines, which may run to the surface or be connected to a local reservoir. For some embodiments, a single precursor may be flowed into the chamber, for example, with the precursor designed to react with fluid contents of a flowline.

To facilitate launching the foam pig, backpressure is built within the chamber, at block 106. Once sufficient back pressure is built the foam pig launches from the chamber into the flowline, at block 108. After being launched into the flowline, pressure in the flowline pushes the foam pig down the flowline, as shown in block 110. The chamber into which the precursors were flowed in block 102 may be cleaned, at block 112.

The in-situ generated foam pigs may be used for a number of purposes. They may be used for commissioning or operational pigging. For operational pigging, the foam pigs may be used alone for cleaning or could be used to deliver batch treatments. Some examples of batch treatments include corrosion inhibitors, methanol treatments for hydrates, and xylene treatments for asphaltenes. Because the delivery of these foam pigs is simplified in comparison to other pigging procedures, more frequent pigging may be utilized to maintain the system.

Referring to FIG. 2, a portion of a fluid transportation assembly or system 200 may include an apparatus for forming a foam pig (in-situ) in accordance with one embodiment of the present invention. As illustrated, the portion of the fluid transportation system 200 provides a primary flow path from a first location to a second location through tubular members. As an example, the primary flow path may travel from a production tree to a processing facility. The direction of fluid in the primary flow path through the flowline 205 (primary flow path) is indicated by an arrow 215. To form a foam pig, a main valve 225 and an alternative flowline 220 are coupled to the primary flow path 205 to provide an alternative flow path. The main valve 225 may be manually, electrically, or hydraulically operated system for selectively opening and closing production fluid flow through the flowline 205. Further, the main valve 225 may be remotely and selectively opened and closed via a respective actuator (not shown).

The portion of the primary flow path that is diverted to the alternate flow path through an alternative flowline 220 provides access to a chamber 210. This alternative flow path may be activated by closing main valve 225 and opening a kicker valve 230. This alternative flow path may be used to build backpressure to launch an in-situ formed foam pig 270 into the flowline downstream of the chamber 210. During normal operation, as well as when forming a foam pig, the chamber 210 may be isolated from primary flow path by closing the kicker valve 230 and a chamber isolation valve 235. These valves may be any type of valve commonly employed to control the flow of production fluids through tubular members and may be remotely and/or selectively opened and closed via a respective actuator (not shown).

Further, the chamber 210 may also be in communication with one or more valves, which may include a first injection valve 260, a second injection valve 262, a purge valve 250 and a drain valve 255. These valves 250, 255, 260 and 262 may be any type of valve commonly employed to control the flow of production fluids or other fluids through the flowline and may also be remotely and selectively opened and closed via a respective actuator (not shown). Although the current embodiment has two injection valves 260 and 262, the present techniques may use any number of valves dependent upon the specific configurations desired or different material to be injected into the fluid transportation system 200. The injection valves 260 and 262 are connected with one or more lines (not shown) configured to deliver one or more precursors to the chamber 210. The injection lines may be connected to a production platform located at the surface. For some embodiments, a single injection line may carry a precursor designed to react with the produced fluid and/or naturally occurring moisture in the chamber 210.

The purge and/or drain valves 250 and 255 may be provided to allow the chamber to be purged (e.g., with a pressurized gas) and to allow precursors and/or production fluids to be drained from the chamber 210. Some embodiments may utilize a drain valve 255, allowing the chamber 210 to be cleaned without the use of a purge valve 250.

In effect, the chamber 210 functions as a mold for creating a foam pig 270. The shape of the chamber 210 is cylindrical with an inner diameter D_{C} similar to the inner diameter D_{P} of the flowline 205, such that the foam pig 270 conforms to the inner wall of the flowline 205. Preferably, the inner diameter D_{C} of the chamber 210, and the associated diameter of the foam pig 270 is slightly larger than the inner diameter D_{P} of the flowline 205. Thus, the dimensions of the foam pig 270 may be sufficient to ensure adequate contact with the inner surface of the flowline as the foam pig 270 moves through the flowline, thereby increasing the ability of the foam pig 270 to clean the inner surface of the flowline. Although this embodiment includes a foam pig 270 with a cylindrical shape, this invention may be practiced with pigs of different shapes (e.g. spherical or ellipsoidal) with the ultimate shape determined by the design of the chamber 210.

In one embodiment, the chamber 210 comprises one or more heaters (not shown) because the curing time for the precursors may be affected by the temperature of the environment. That is, low temperatures may lengthen the cure time, while higher temperatures may reduce the cure time. At a temperature of about 25° Celsius (C.) and atmospheric pressure, a thermosetting polyurethane resin may take up to a day to fully cure, while increasing the temperature to about 100° C. may reduce the cure time to a few hours. As the temperature of the chamber 210 may be similar to the water temperature at the sea floor for subsea use, which can approach 0° C., the temperature of the chamber 210 may significantly increase the cure time or even prevent the precursors from fully curing. The heater allows for active heating of the chamber 210 to reduce the time required for reaction (i.e. cure time) of the precursors. The heater surrounds a portion of the exterior of the chamber 210 to heat the chamber and its contents. This heating may be provided in a uniform manner by surrounding a substantial portion of the chamber 210. If the production fluids are at an elevated temperature relative to the surrounding environment, the production fluids may be used as a heat source for heating the chamber 210. This may be provided by diverting a portion of the fluid flow through the main flowline 205 to a secondary flow path around or through the chamber 210, such as, for example, a jacket surrounding the chamber 210.

For some embodiments, precursors, such as thermosetting resin systems, used for forming the foam pig 270 may adhere to metal surfaces. Accordingly, the inner surface or wall of the chamber 210 may preferably be coated with a layer of material that the thermosetting resin system does not adhere to. For example, a high-density polyethylene layer may be utilized for moderate temperatures from about −40° C., which represents the lower bound operating temperature for onshore lines, to about 40° C., the temperature at which this material begins to deform under pressure. A polytetraflouroethylene (e.g. Teflon®) coating may be used for more severe temperatures from about −40° C. to about 260° C., the temperature at which this material begins to degrade. Other layer or coating materials known in the art may also be used to line the inner wall of the chamber 210.

To provide the precursors to the chamber 210, various different embodiments may be utilized. For example, if the system is coupled to a host platform, the precursors may be delivered from the host platform to the chamber 210 through chemical injection lines in an umbilical. In this embodiment, the precursors may be pumped continuously or delivered as a slug pushed by another fluid. If precursors are delivered as slugs, the chemical injection lines can be used for other purposes, such as methanol injection, when pigging operations are not being performed. The use of chemical injection lines provides the flexibility to remotely perform the pigging operations from the host platform. In another embodiment, if the system is coupled to storage tanks, the storage tanks (not shown) adjacent to the chamber 210 may deliver the precursors to the chamber 210. The storage tanks may be periodically refilled or replaced through the use of umbilical lines and/or an ROV. In this embodiment, the shelf-life of the precursors (i.e. resins) may be limited by the storage life of the precursors. For example, commercially available polyurethane resin systems have a rated shelf-life on the order of one year at ambient conditions. The shelf-life of the resin precursors may be lengthened by adding a stabilizer or storing at low temperature thus making the use of a storage tank system more feasible.

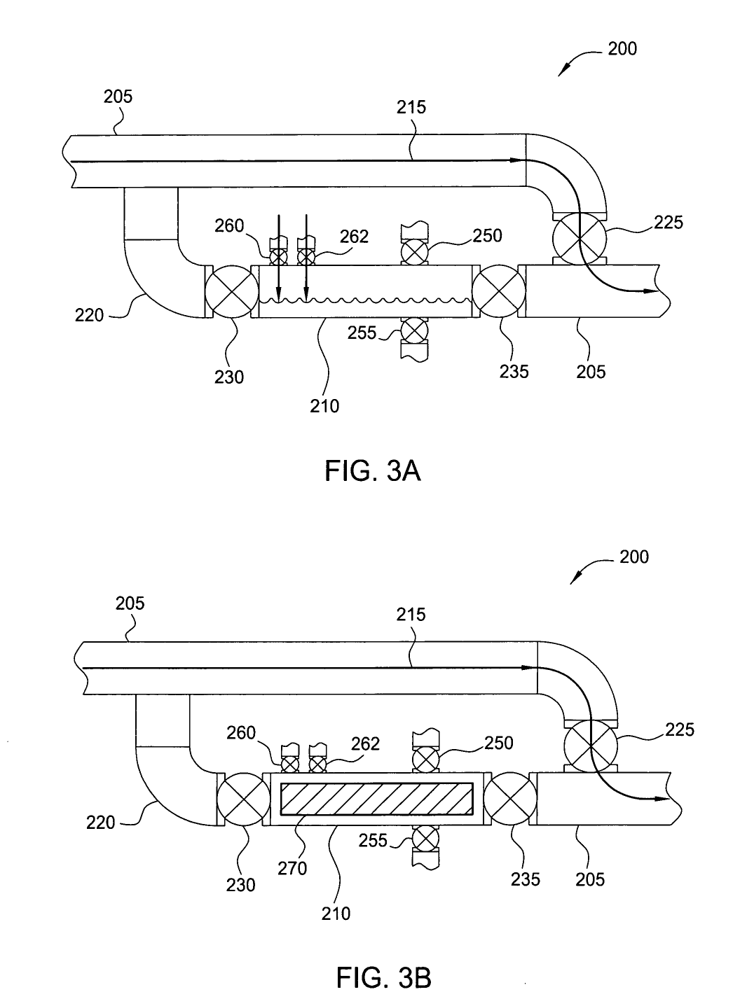

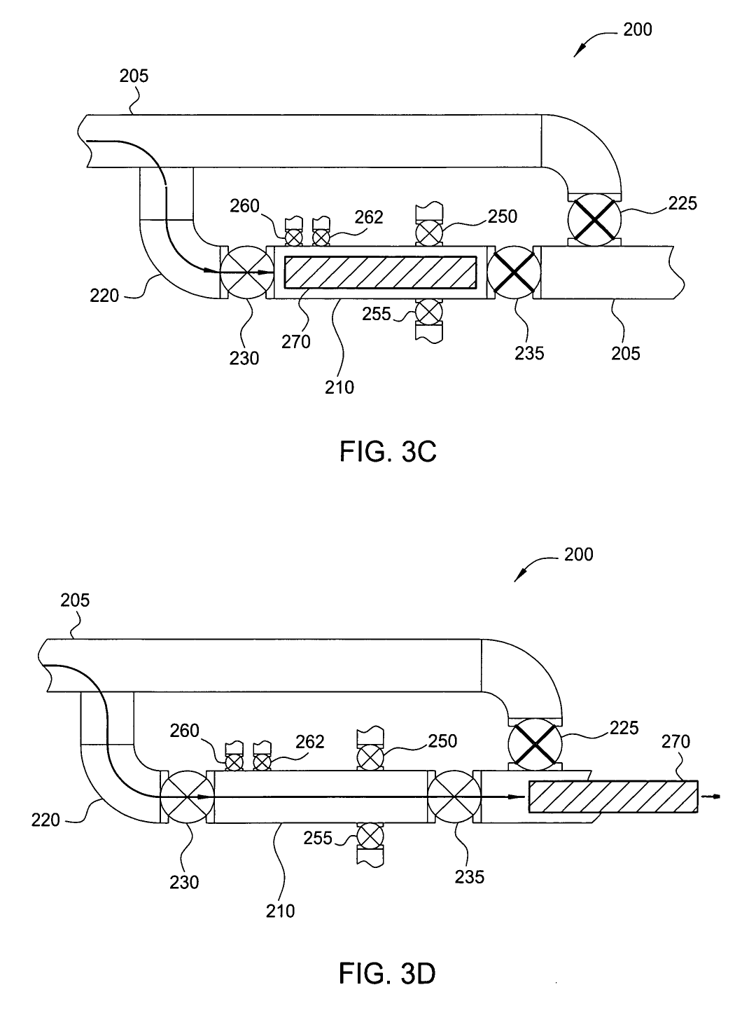

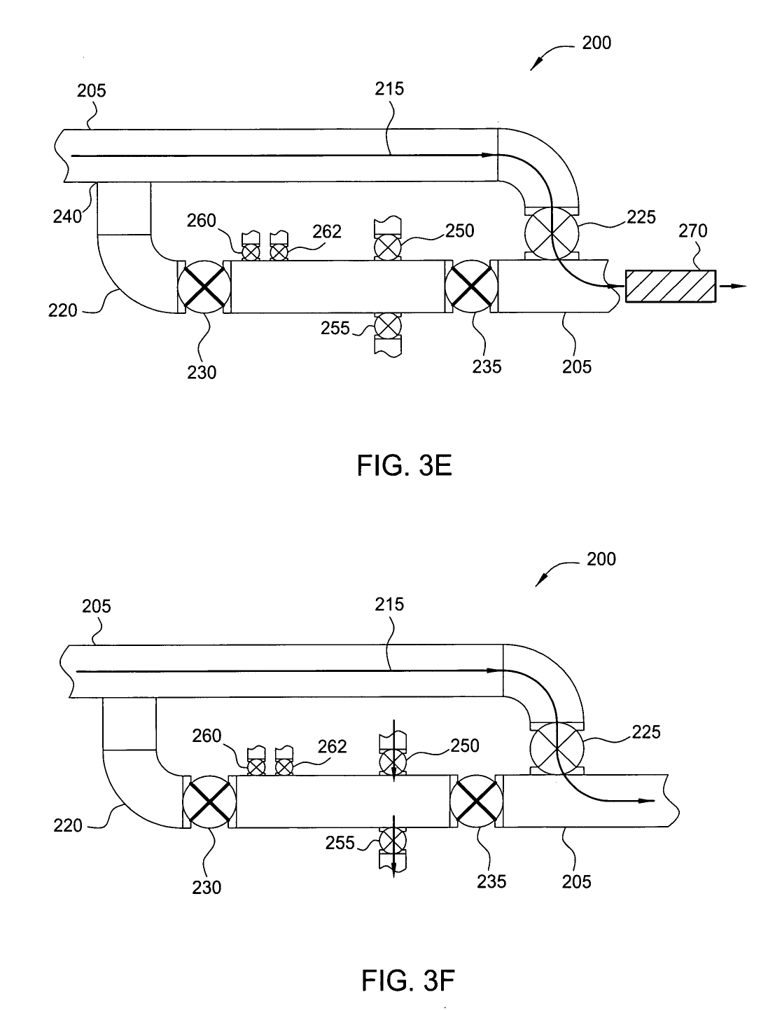

The operations introduced previously and shown in FIG. 1 may be described in conjunction with FIGS. 2 and 3A-3F, which show the embodiment of the apparatus in the portion of the fluid transportation system 200 of FIG. 2 at different stages corresponding to the pigging operations of FIG. 1. FIG. 2 illustrates the portion of the fluid transportation system 200 in what may be considered a normal operational stage, with the fluid flows through the flowline 205, the main valve 225, which is placed in the open position. In this state, the chamber 210 is isolated from the flowline 205 by the chamber isolation valve 235 and kicker valve 230, which are placed in closed positions. Also, the injection valves 260 and 262, drain valve 255 and purge valve 250 are placed in the closed position to further isolate the chamber 210.

Pigging operations that form the foam pig in-situ in block 102 begin by flowing precursors into the chamber 210. As illustrated in FIG. 3A, the precursors may be flowed into the chamber 210 by opening valves 260 and 262, without interrupting the fluid flow through the flowline 205 (i.e. main valve 225 remains in the open position).

As shown in FIG. 3B, the precursors are cured in the chamber 210 to form the foam pig 270 in-situ, as discussed in block 104. Upon mixing, the precursors, which may be resin components, may react to form a rigid foam pig 270. During the reaction, the foam may expand to completely or at least partially fill the inside of the chamber 210. In some situations, the inner surface of the chamber 210 may be patterned, for example, to form the foam pig 270 with features designed to enhance cleaning, such as ridges on the outer surface of the pig. After curing, the foam pig 270 may be ready for launch in to the flowline 205.

Prior to launching, backpressure is applied to the pig 270 by diverting the contents of the flowline 205 to the chamber 210, as discussed in block 106 and shown in FIG. 3C. The pressure may be increased up to that of the flowline by adjusting the kicker valve 230 to the open position, while adjusting the main valve 225 to the closed position. In FIG. 3D, the chamber isolation valve 235 is adjusted into the open position to launch the foam pig 270 into the flowline 205, as discussed in block 108.

After the foam pig 270 has been launched, the kicker valve 230 and the chamber isolation valve 235 are adjusted into the closed position, and the main valve 225 is adjusted into the open position, as shown in FIG. 3E. The adjustments to the kicker valve 230 and the chamber isolation valve 235 isolates the chamber 210 from the flowline 205 and restores the fluid flow through the main valve 225. In FIG. 3F, the drain valve 255 is adjusted into the open position to drain the production fluids from the chamber 210, as discussed in block 112. A purge valve 250 may also be adjusted into the open position to deliver a pressurized gas to aid the removal of production fluids from the chamber 210. After draining the contents from the chamber 210, the drain valve 255 and the purge valve 250 are adjusted into the closed position. After block 112, the pigging process has completed a full cycle of pigging operations and normal operation may resume, which is shown in FIG. 2.

Referring to FIG. 4, another portion of an exemplary fluid transportation system 400 includes an apparatus for generating an in-situ foam pig in accordance with another embodiment of the present invention. In this embodiment, the precursors may be introduced directly into the flowline 405 to create a foam pig. The direction of production fluid flow through the flowline 405 is indicated by an arrow 415.

In this portion of the fluid transportation system 400, the flowline 405 has a main valve 410 and a pair of injection valves 420, 422 connected with one or more injection lines (not shown) configured to deliver one or more precursors to the flowline 405. The injection lines may again be connected to a production facility or storage tank, as discussed above. Further, the flowline 405, main valve 410 and injection valves 420 and 422 may be similar to the main flowline 205, main valve 225 and injection valves 260 and 262 of FIG. 2, respectively.

During normal or production operations, the valves 420 and 422 are placed in the closed position, while the main valve 410 may be placed in the open. During pigging operations, the main valve 410 is adjusted into a closed position to temporarily stop the flow of production fluids in the flowline 405. The injection valves 420, 422 are adjusted to the open position to provide precursors into the flowline 405. After the precursors are delivered to the flowline 405, the injection valves 420 and 422 are adjusted into the closed position. The precursors are cured in the flowline 405 to form a foam pig in-situ, and the main valve 410 is adjusted back into the open position to launch the foam pig and restore the fluid flow of production fluids through the main flowline 405. Once back in the normal operation setting, the process has completed a full cycle of pigging operations and is ready to either create and launch another foam pig or maintain normal operations.

By eliminating the separate chamber and corresponding valves of system 200, a relatively simple method for forming pigs and performing the pigging operations is provided by the apparatus in exemplary system 400. While the pigging operations may involve a temporary interruption of fluid flow when generating a foam pig in-situ, the apparatus may provide a low cost solution that involves the addition of a few valves to typical fluid transportation systems. That is, injection valves may be added with a main valve in the fluid flow path to provide the apparatus for forming a foam pig.

FIG. 5 is a schematic diagram of a mixing apparatus 500 for generating an in-situ foam pig in accordance with another embodiment of the present invention. Because it may be difficult to obtain adequate mixing of the resin precursors by separately introducing the precursors into the chamber 210 or directly into the flowline 405, a mixing chamber 510 may be utilized. The mixing chamber 510 may be added to the above embodiments of the fluid transportation systems 200 and 400 to allow the precursors, such as resin components, to mix and partially react prior to their introduction to the chamber 210 or directly into the flowline 405. The impingement mixing chamber 510 may also reduce the effects of production fluids on the reaction when the precursors are introduced directly into the flowline 405, as shown in FIG. 4. For example, the impingement mixing chamber 510 may be placed between the injection valves 260, 262 and the chamber 210 of FIG. 2 and between the injection valves 420, 422 and the flowline 405 of FIG. 4.

As shown in the mixing apparatus 500, the impingement mixing chamber 510 comprises injection valves 520 and 522, a purge valve 525, and an isolation valve 530. The injection valves 520 and 522, and purge valve 525 may be similar to the injection valves 260 and 262 and purge valve 250 of FIG. 2, respectively. The isolation valve 530 may be any type of valve commonly employed to control the flow of fluids through tubular members and may be remotely and/or selectively opened and closed via a respective actuator (not shown).

To operate, the various valves 520, 522, 525 and 530 may be adjusted into various positions to provide or isolate fluid flow paths through the respective system. In normal operations, the injection valves 520 and 522, the purge valve 525, and the isolation valve 530 of the impingement mixing chamber 510 are placed in the closed position, and the impingement mixing chamber 510 may be empty. During pigging operations, the injection valves 520 and 522 are adjusted into the open position to deliver precursors from injection lines (not shown) into the impingement mixing chamber 510. The precursors may partially react in the impingement mixing chamber 510. Then, the isolation valve 530 is adjusted to the open position to allow the precursors to expand into the chamber 210 or the flowline 405, as they continue to react. As may be appreciated, the injection valves 520 and 522 may be adjusted to the closed position prior to the opening of the isolation valve 530 or at some time after the isolation valve is opened. This may depend upon the size of the impingement mixing chamber 510 and the amount of precursors utilized to form the foam pig. Regardless, the purge valve 525 may be adjusted to the open position to expel the partially reacted precursors from the impingement mixing chamber 510 prior to the closing of the isolation valve 530. Then, valves 520, 522, 525 and 530 may be adjusted to the closed position for the pigging operations to complete a full cycle based on the specific procedure of the respective system.

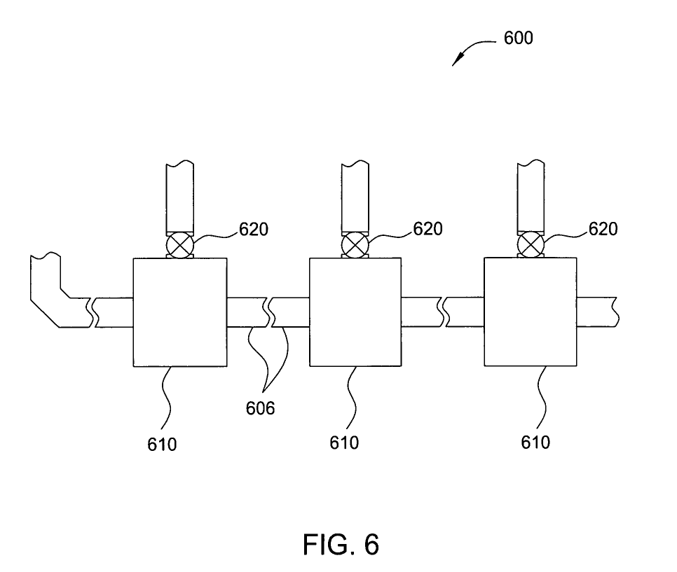

For some embodiments, foam pigs may be formed in-situ at multiple locations along a fluid transportation system. For example, as illustrated in FIG. 6, a plurality of in-situ foam pig generation apparatuses 610 may be positioned at different locations along a pipeline 600 FIG. 6. The apparatus 610 may comprise any configuration of components suitable for forming foam pigs in-situ to be transported through a flowline 606, such as those previously described with reference to FIGS. 2-5. For example, the apparatus 610 may each be attached to and utilize one or more valves 620, which may be injection valves 260 and 262, to flow one or more precursors to be used in forming a pig in-situ. The apparatus 610 may also be attached to and utilize one or more valves 620, which may be drain or purge valves 255 and 250. Regardless, the number of valves 620 may be based on the specific embodiments utilized for the apparatus 610, which are discussed above.

As previously described, a foam pig may wear or decompose after traveling some distance along the length of the flowline. Thus, the distance between the apparatus 610 may be selected based on an expected rate at which the foam pigs lose their ability to clean or operate effectively. By utilizing multiple apparatus in this manner, effective cleaning may be achieved efficiently for long flowlines or those with complex flowline topologies, which may include branches, varying flowline diameters and sharp bends.

To form the foam pig, several types of thermosetting resin systems may be suitable as the precursors. The preferred type of thermosetting resin system includes a two-component polyurethane resin. For this type of thermosetting resin system, the components remain stable until mixed together where they then react to form a rigid foam. At ambient temperature, the rise time after mixing is on the order of a few minutes, and curing is complete in approximately one day. The two-component polyurethane foam systems may provide foam pigs having a wide range of densities (2-16 pound per cubic foot (lb/ft³)), covering the range of densities most likely used for commercial foam pigs.

Other types of thermosetting resin systems, such as different resin chemistries or single- or multi-component (i.e., greater than two components) resin systems, may also be utilized to form a foam pig in-situ. For example, single-component polyurethane foams, which cure in the presence of water, are commercially available and may be flowed into a chamber to form a foam pig when reacting with naturally occurring water in the chamber. If a single- or multi-component precursor system is used, as discussed above, the number of valves needed to deliver the resin components may be adjusted from the two injection valves described in the above embodiments. For instance, only a single injection valve may be necessary for precursor delivery if a single-component system is used.

As another enhancement to the formation of the foam pig, the thermosetting resin system may be modified to aid processing or alter the properties of the foam pig. For instance, the precursors may be diluted with a solvent or utilize a special precursor formulation to lower viscosity. This modification may make it easier to pump the precursors through the injection valve. Also, modified precursor formulations may minimize the effect of production fluids on the reaction when precursor components are introduced directly to the flowline, as shown in FIG. 4. Adding inorganic fillers, such as silica or carbon black, may further increase the wear resistance and cleaning ability of the foam pig in other embodiments. Adding a tracer, such as iron filings, may assist in detecting the location of the foam by a non-intrusive pig detector. The pig detector (not shown), which is well known in the art, may be installed along the flowline to provide further information about the location of the foam pig via a signal to monitoring equipment.

In addition, it may be possible to create a foam pig from a thermoplastic rather than a thermosetting resin system. A thermoplastic based pig may be advantageous in that it could be dissolved with a solvent and or applied heat. Accordingly, this type of pig may be removed if it became stuck or if the flowline to be pigged only had one point of entry. To pig lines with only one point of entry, the flow is typically reversed to retrieve the pig. This approach may reduce the time and efforts spend to remove the pig for these applications.

Generating a thermoplastic pig may require modifications to the apparatus shown because the precursor is a solid rather than a liquid. Application of heat and pressure may also be required to soften and consolidate the thermoplastic, and a pressurized gas foaming agent may then be introduced to generate a foam.

While the foregoing is directed to embodiments of the present invention, other and further embodiments of the invention may be devised without departing from the basic scope thereof, and the scope thereof is determined by the claims that follow.

We claim:

1. Method of operating a fluid transportation system comprising:
a) flowing one or more precursors into a first portion of a fluid transportation system;
b) curing the precursors within the fluid transportation system to form a foam pig;
c) moving the foam pig through a second portion of the fluid transportation system; and
d) repeating steps a)-c) at different locations along the fluid transportation system.

2. The method of claim 1, wherein flowing one or more precursors into a first portion of a fluid transportation system comprises flowing at least two precursors into the first portion of the fluid transportation system.

3. The method of claim 2, wherein the at least two precursors comprise components of a thermosetting resin system that react to form a rigid foam when mixed.

4. The method of claim 2, wherein the at least two precursors comprise a thermoplastic and a gaseous foaming agent.

5. The method of claim 2, further comprising mixing at least two of the precursors in a chamber prior to curing the precursors in the fluid transportation system.

6. The method of claim 5, wherein the precursors are mixed and cured in separate chambers.

7. The method of claim 1, wherein the precursors are cured in a chamber to form the foam pig; and the precursors are launched from the chamber into the second portion of the fluid transportation system.

8. The method of claim 1, wherein the fluid transportation system is a hydrocarbon transportation system.

9. The method of claim 8, wherein one or more of the precursors react with hydrocarbons in the hydrocarbon transportation system to form the foam pig.

10. The method of claim 1, further comprising adding inorganic fillers to the precursors to increase the wear resistance and cleaning ability of the foam pig.

11. The method of claim 1, further comprising heating the precursors during the curing step to reduce the time required to allow the precursors to form the foam pig.

12. A method for pigging a flowline configured for transporting production fluids, the method comprising:
providing a plurality of chambers in communication with the flowline;
flowing precursors into at least one of the plurality of chambers;
allowing the precursors to cure in the at least one of the plurality of chambers to form a foam pig in-situ;
building back pressure in the at least one of the plurality of chambers; and
launching the foam pig from the at least one of the plurality of chambers into the flowline.

13. The method of claim 12, wherein the precursors comprise one of components of a thermosetting liquid resin system or a thermoplastic and gaseous foaming agent.

14. The method of claim 12, wherein flowing precursors into the at least one of the plurality of chambers comprises injecting the precursors into the at least one of the plurality of chambers via one or more remotely operated valves.

15. The method of claim 12, wherein launching the foam pig from the at least one of the plurality of chambers into the flowline comprises diverting the flow of production fluids from the flowline to the at least one of the plurality of chambers.

16. The method of claim 15, further comprising pushing the foam pig through the flowline by restoring the flow of production fluids through the flowline.

17. The method of claim 12, further comprising draining fluids from the chamber.

18. The method of claim 17, further comprising delivering a pressurized gas to the chamber to remove production fluids.

19. The method of claim 12, further comprising adding inorganic fillers to the precursors to increase the wear resistance and cleaning ability of the foam pig.

20. The method of claim 12, further comprising heating the precursors during the curing step to reduce the time required to allow the precursors to form the foam pig.

21. An apparatus for in-situ formation of a foam pig for pigging a subsea flowline configured to transport production fluids, the system comprising:
a plurality of chambers in fluid communication with the flowline;
a pair of valves mounted on opposing ends of each of the plurality of chambers, the pair of valves including a kicker valve located at an upstream end of each of the plurality of chambers and a chamber isolation valve located at a downstream end of each of the plurality of chambers;
one or more injection valves connected with each of the plurality of chambers, the injection valves configured to deliver one or more precursors to each of the plurality of chambers for formation of the foam pig; and
a control apparatus allowing in-situ formation of the foam pig by remotely operating the pair of valves and the one or more injection valves to:
i) isolate at least one of the plurality of chambers from the flowline by closing the kicker valve and chamber isolation valve;
ii) flow the one or more precursors into the at least one of the plurality of chambers by opening the injection valves, and, after allowing the precursors to cure to form the foam pig;
iii) opening the kicker valve to build back pressure in the at least one of the plurality of chambers; and
iv) opening the chamber isolation valve to propel the foam pig into the flowline.

22. The apparatus of claim 21, wherein each of the plurality of chambers is cylindrical with an inner diameter greater than the inner diameter of the flowline.

23. The apparatus of claim 21, further comprising a well configured to generate production fluids in communication with the flowline.

24. The apparatus of claim 21, wherein each of the plurality of chambers comprises a drain valve movable between open and closed positions, the drain valve configured to drain production fluids from each of the plurality of chambers.

25. The apparatus of claim 24, wherein each of the plurality of chambers further comprises a purge valve configured to deliver a pressurized gas to each of the plurality of chambers and to aid in the removal of production fluids from each of the plurality of chambers.

26. The apparatus of claim 21, further comprising a plurality of mixing chambers in communication with the injection valves and the plurality of chambers, the plurality of mixing chambers configured to allow the precursors to mix and partially react prior to their introduction into each of the plurality of chambers.

27. The apparatus of claim 21, wherein the precursors comprise a two component polyurethane resin system.

28. The apparatus of claim 21, wherein the foam pig further comprises inorganic fillers configured to increase the wear resistance and cleaning ability of the foam pig.

29. The apparatus of claim 21, wherein each of the plurality of chambers further comprises a heater configured to reduce the time required to allow the precursors to cure to form the foam pig.

30. The apparatus of claim 21, wherein each of the plurality of chambers comprises in inner wall lined with a coating configured to reduce adherence between the foam pig and the inner wall.

31. The apparatus of claim 30, wherein the coating is selected from a group consisting of polyethylene, polytetraflouroethylene, and combinations or derivatives thereof.

32. The apparatus of claim 21, further comprising one or more injection lines connected with a host platform and configured to deliver the one or more precursors from the host platform to each of the plurality of chambers.

33. The apparatus of claim 32, wherein the precursors are delivered as a slug through the injection lines.

34. The apparatus of claim 32, wherein the precursors are pumped continuously through the injection lines.

35. A fluid transportation system, comprising:
a flowline for transporting fluids; and
a plurality of pig forming apparatuses, each located at a different position along the flowline and configured to form, from one or more precursors cured in-situ, a pig to be moved through a portion of the flowline.

36. The system of claim 35, wherein the flowline transports hydrocarbons along a pipeline.

37. The system of claim 35, wherein the flowline transports hydrocarbons from a wellbore.

38. The system of claim 35, wherein each of the plurality of pig-forming apparatuses comprises:
a chamber for curing the one or more precursors to form the pig and from which the pig is launched into the flowline.

39. The system of claim 35, wherein each of the plurality of pig-forming apparatuses comprises:
a chamber for pre-mixing the one or more precursors prior to curing the one or more precursors.

40. The system of claim 35, wherein each of the plurality of pig-forming apparatuses is configured to form a pig in-situ in a portion of the flowline.

41. The system of claim 35, wherein each of the plurality of apparatuses comprises one or more reservoirs for holding one or more of the precursors.
